(19) United States
(12) Patent Application Publication
(10) Pub. No.: US 2023/0394088 A1
(43) Pub. Date: Dec. 7, 2023

(54) TASK SUPPORT SYSTEM, TASK SUPPORT METHOD, AND INFORMATION STORAGE MEDIUM

(71) Applicant: Cybozu, Inc., Tokyo (JP)

(72) Inventors: Akihisa KOYAMA, Tokyo (JP); Ryotaro NAKAGAWA, Matsudo-shi (JP); Shuyo NAKATANI, Tokyo (JP)

(21) Appl. No.: 18/326,022

(22) Filed: May 31, 2023

(30) Foreign Application Priority Data
Jun. 3, 2022 (JP) 2022-090796

(51) Int. Cl. G06F 16/9035; G06F 16/9038

(52) U.S. Cl. CPC G06F 16/9035; G06F 16/9038

(57) ABSTRACT

Provided is an information sharing system including at least one processor configured to: acquire a use status of use by each of a plurality of users for each of a plurality of functions relating to an information sharing service for sharing information; and execute, for each of the functions, predetermined processing relating to the function based on the use status of the function.

### CROSS-REFERENCE TO RELATED APPLICATION

The present disclosure contains subject matter related to that disclosed in Japanese Patent Application JP 2022-090796 filed in the Japan Patent Office on Jun. 3, 2022 the entire contents of which are hereby incorporated by reference.

### BACKGROUND OF THE INVENTION

### 1. Field of the Invention

The embodiments disclosed herein relate to a task support system, a task support method, and an information storage medium.

### 2. Description of the Related Art

Hitherto, there has been known a task support system for supporting each of a plurality of users in tasks. For example, various kinds of data such as comments and schedules are registered in the task support system. A user can leave a reaction such as a like or an emoji to each individual piece of data. In the webpage at https://slack.com/intl/ja-jp/help/articles/202528808-Slack-%E5%86%85%E3%81%AE%E6%A4%9C%E7%B4%A2%E6%96%B9%E6%B3%95, a task support system involving retrieving comments that contain a specific emoji reaction and displaying a search result screen is described.

For example, in the task support system, as the number of reactions to each individual piece of data becomes larger, this piece of data is more likely to include information important to a user. For that reason, when the search result screen can be displayed in consideration of the number of reactions to data, convenience of the user is expected to increase. However, in the technology as described in the webpage at https://slack.com/intl/ja-jp/help/articles/202528808-Slack-%E5%86%85%E3%81%AE%E6%A4%9C%E7%B4%A2%E6%96%B9%E6%B3%95, the search result screen is merely displayed by retrieving messages containing a specific emoji reaction, and hence the convenience of the user cannot be sufficiently increased.

### SUMMARY OF THE INVENTION

One object of the present disclosure is to increase convenience of a user in a task support system that allows a reaction to be made to data.

According to at least one aspect of the present disclosure, there is provided a task support system for supporting each of a plurality of users in tasks, the task support system including at least one processor configured to: receive a reaction to each of a plurality of pieces of data registered in the task support system; acquire the number of reactions to each of the plurality of pieces of data; and display, on a display unit, a search result screen that shows search results relating to the plurality of pieces of data based on the number of reactions to each of the plurality of pieces of data.

### BRIEF DESCRIPTION OF THE DRAWINGS

FIG. 1 is a diagram for illustrating an example of a hardware configuration of a task support system.

FIG. 2 is a view for illustrating an example of a portal screen.

FIG. 3 is a view for illustrating an example of a space screen.

FIG. 4 is a view for illustrating an example of a search result screen.

FIG. 5 is a view for illustrating an example of how a sort condition relating to reactions is designated.

FIG. 6 is a view for illustrating an example of how a filter condition relating to reactions is designated.

FIG. 7 is a view for illustrating an example of how a final search range is identified from checkboxes.

FIG. 8 is a view for illustrating an example of how a search range is switched by a tab.

FIG. 9 is a functional block diagram for illustrating functions implemented by the task support system.

FIG. 10 is a table for showing an example of a user database.

FIG. 11 is a table for showing an example of a task support database.

FIG. 12 is a flow chart for illustrating an example of processing to be executed by the task support system.

FIG. 13 is a diagram for illustrating an example of functional blocks in modification examples.

FIG. 14 is a view for illustrating an example of a search result screen in Modification Example 7.

### DESCRIPTION OF THE EMBODIMENTS

[1. Hardware Configuration of Task Support System]

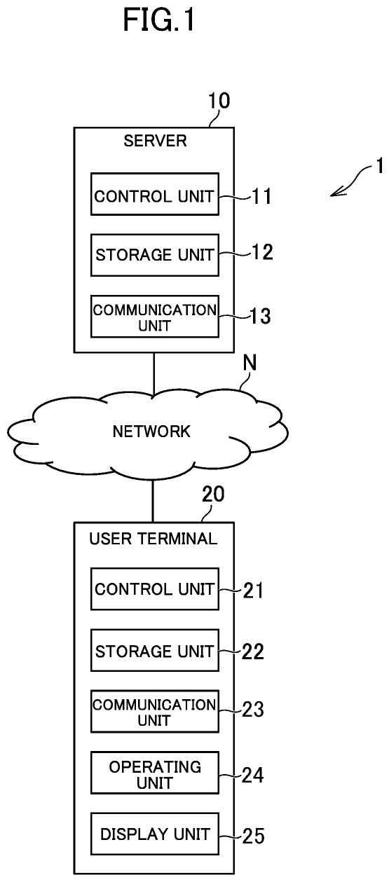

An example of a task support system according to at least one embodiment of the present disclosure is described. FIG. 1 is a diagram for illustrating an example of a hardware configuration of the task support system. For example, a task support system 1 includes a server 10 and a user terminal 20. The server 10 and the user terminal 20 are each connected to a network N, such as the Internet or a LAN.

The server 10 is a server computer. For example, the server 10 includes a control unit 11, a storage unit 12, and a communication unit 13. The control unit 11 includes at least one processor. The storage unit 12 includes a volatile memory such as a RAM, and a non-volatile memory such as a flash memory. The communication unit 13 includes at least one of a communication interface for wired communication or a communication interface for wireless communication.

The user terminal 20 is a computer of a user. For example, the user terminal 20 is a personal computer, a tablet terminal, or a smartphone. For example, the user terminal 20 includes a control unit 21, a storage unit 22, a communication unit 23, an operating unit 24, and a display unit 25. Hardware configurations of the control unit 21, the storage unit 22, and the communication unit 23 may be the same as those of the control unit 11, the storage unit 12, and the communication unit 13, respectively. The operating unit 24 is an input device, such as a mouse, a touch panel, or a keyboard. The display unit 25 is a liquid crystal display or an organic EL display.

Programs stored in the storage units 12 and 22 may be supplied through the network N. Hardware configurations of the server 10 and the user terminal 20 are not limited to the examples of FIG. 1. For example, a reading unit (for example, optical disc drive or memory card slot) for reading a computer-readable information storage medium or an input/output unit (for example, USB terminal) for directly connecting to an external device may be included. In this case, programs stored in the information storage medium may be supplied through intermediation of the reading unit or the input/output unit.

Further, the task support system 1 is only required to include at least one computer. The computers included in the task support system 1 are not limited to the example of FIG. 1. For example, the task support system 1 is not required to include the user terminal 20. In this case, the user terminal 20 is present outside the task support system 1, and the task support system 1 includes only the server 10. The task support system 1 may include the server 10 and another server computer.

[2. Outline of Task Support System]

The task support system 1 is a system for supporting each of a plurality of users in tasks. The task support system 1 can be ready for any type of industry. A series of services provided by the task support system 1 is sometimes called groupware. In the at least one embodiment, the task support system 1 of a cloud type is taken as an example, but the task support system 1 may be of an on-premises type instead of the cloud type.

The task support system 1 provides the users with various functions relating to task support. For example, a schedule sharing function for sharing a schedule, a communication function for communicating through use of a message, a web conference, or the like, and a file sharing function for sharing a file, and a database sharing function for sharing a database may be provided. A user shares information within a group to which the user belongs through use of those functions.

The group is a group of a plurality of users who share information. For example, an organization such as a company or a government office corresponds to the group. A department or a team within the organization also corresponds to the group. The user may share information with another user outside the group, or may share information with an indefinitely large number of other users without any particular concept of the group. For example, when the user operates the user terminal 20 to log in to the task support system 1, a portal screen corresponding to a top page of the task support system 1 is displayed on the display unit 25.

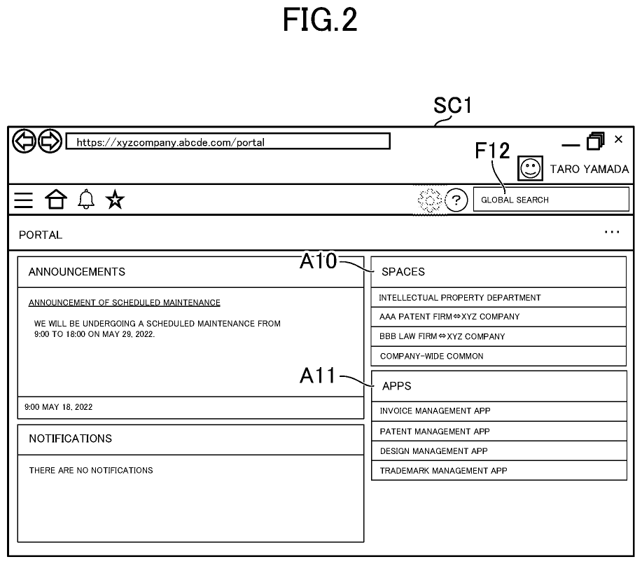

FIG. 2 is a view for illustrating an example of the portal screen. In the at least one embodiment, a case in which each screen is displayed on a browser of the user terminal 20 is described, but each screen may be displayed on a dedicated program installed on the user terminal 20. For example, a list of spaces is displayed in a display area A10. The spaces are each an example of a group joined by each user. When the user selects a space from the display area A10, a space screen corresponding to a top page of the selected space is displayed on the display unit 25.

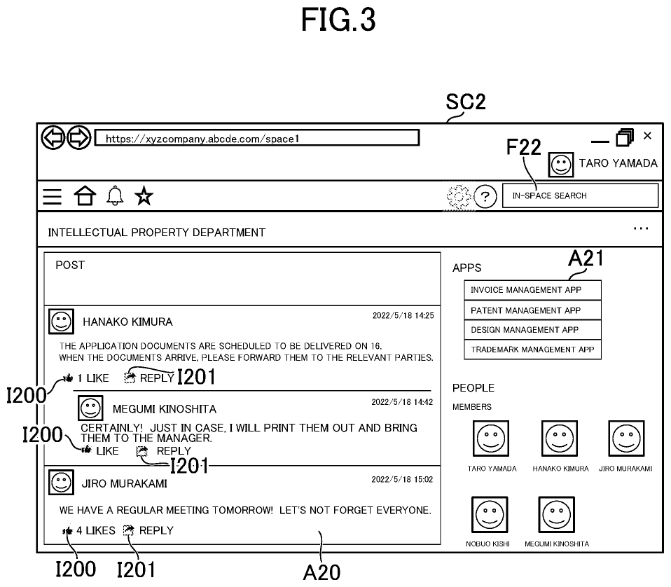

FIG. 3 is a view for illustrating an example of the space screen. For example, on a space screen SC2, various kinds of data shared in the space can be displayed. For example, in a display area A20 of the space screen SC2, threads for communication between users who have joined the space are displayed. For example, a list of apps available to the user is displayed in a display area A21 of the space screen SC2. The list of apps is also displayed in a display area A11 of the portal screen SC1.

The app is a tool for supporting the user's task. The app can also be considered as a task system tailored for the user's work. In the at least one embodiment, an app having the same function as that of spreadsheet software is taken as an example, but as the app itself, various known types of apps can be used. For example, the app may be an app having the same function as that of word-processing software, image editing software, or presentation software. Other functions such as a schedule management function may be provided as a type of app.

For example, the app may include not only records that form a table but also other information such as comments input by the user and files uploaded by the user. Thus, the app has not only a database function equivalent to that of spreadsheet software but also other functions such as a communication function in combination. The user may use an app provided in advance by the task support system 1 or may create and add an app by himself or herself.

Various kinds of data other than threads and apps can be registered in the task support system 1. For example, in the task support system 1, it is possible to register data relating to schedules, data relating to expense applications, data relating to attendance management, or data relating to company regulations. In the at least one embodiment, the user can leave a reaction determined in advance to data allowed to be viewed by the user himself or herself.

The reaction refers to an action taken against data registered by a certain user by another user. The reaction may be an action of the user who has registered the data by himself or herself. Leaving a comment by inputting some character string for the data is one type of reaction, but in the at least one embodiment, a reaction that can be completed with one click or tap is taken as an example. For example, the reaction is a like or emoji reaction.

In the example of FIG. 3, the user can leave a reaction to each individual post by selecting an icon I200 in the display area A20. Data that can be reacted to may be any data, and is not limited to thread posts. For example, it may be possible to react to in-app comments, uploaded files, or schedules of users.

In the at least one embodiment, the user can search data registered in the task support system 1 by designating any search condition. For example, when the user inputs any given keyword into an input form F12 of FIG. 2 or an input form F22 of FIG. 3, a plurality of pieces of data registered in the task support system 1 are searched for pieces of data containing the given keyword. After the search has been executed, a search result screen that shows search results is displayed on the display unit 25.

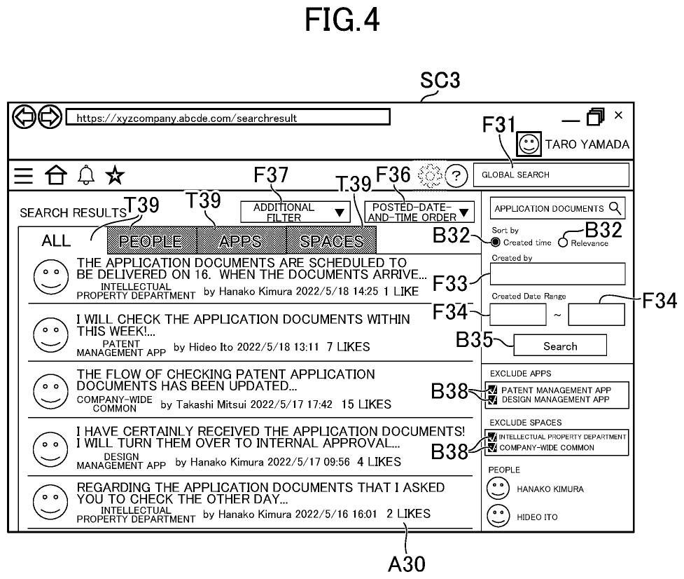

FIG. 4 is a view for illustrating an example of the search result screen. For example, in a display area A30 of the search result screen SC3, a list of pieces of data containing the keyword input by the user is displayed as search results. The display area A30 can be scrolled. The user can perform various operations relating to display of the search results from the search result screen SC3. For example, the user can change the keyword to be contained in the search condition through an input form F31.

For example, the user can change a sort condition for the search results in the display area A30 through a radio button B32. The user can designate a creator of data as a search condition from an input form F33. The user can designate a data creation time range as a search condition from an input form F34. When the user changes at least one of the search conditions and the sort condition and selects a button B35, the display of the display area A30 is updated.

In the at least one embodiment, it is possible to designate a condition relating to reactions to data as a sort condition for the search results in the display area A30. The sort condition is a condition for a display order of pieces of data to be displayed as the search results. For example, the user can designate the sort condition not only from the radio button B32 but also from an input form F36. In the example of FIG. 4, a posted-date-and-time order is designated as the sort condition in the input form F36.

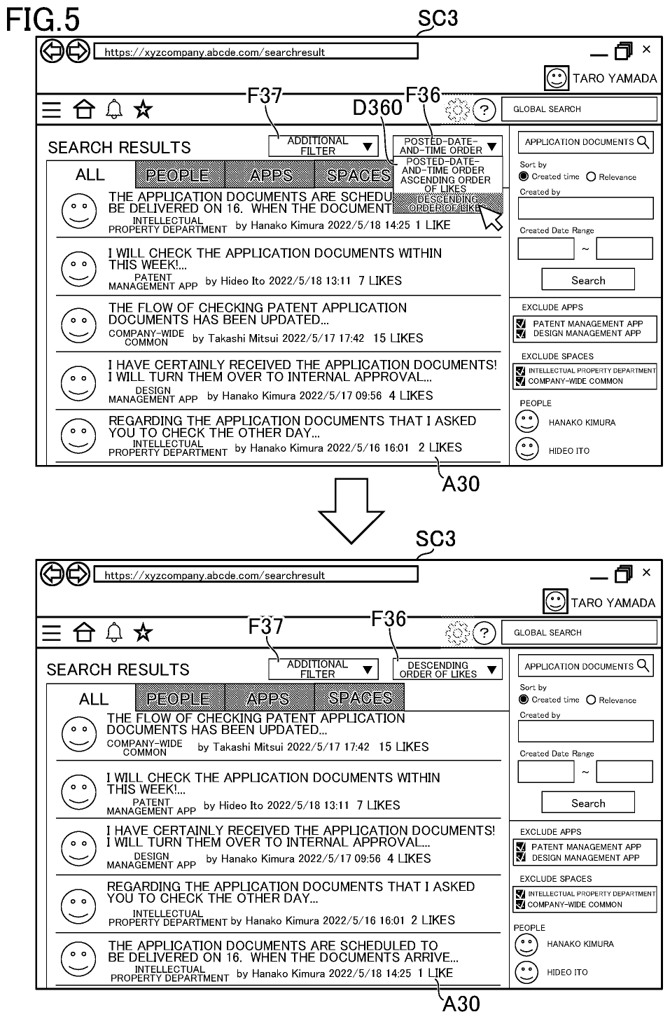

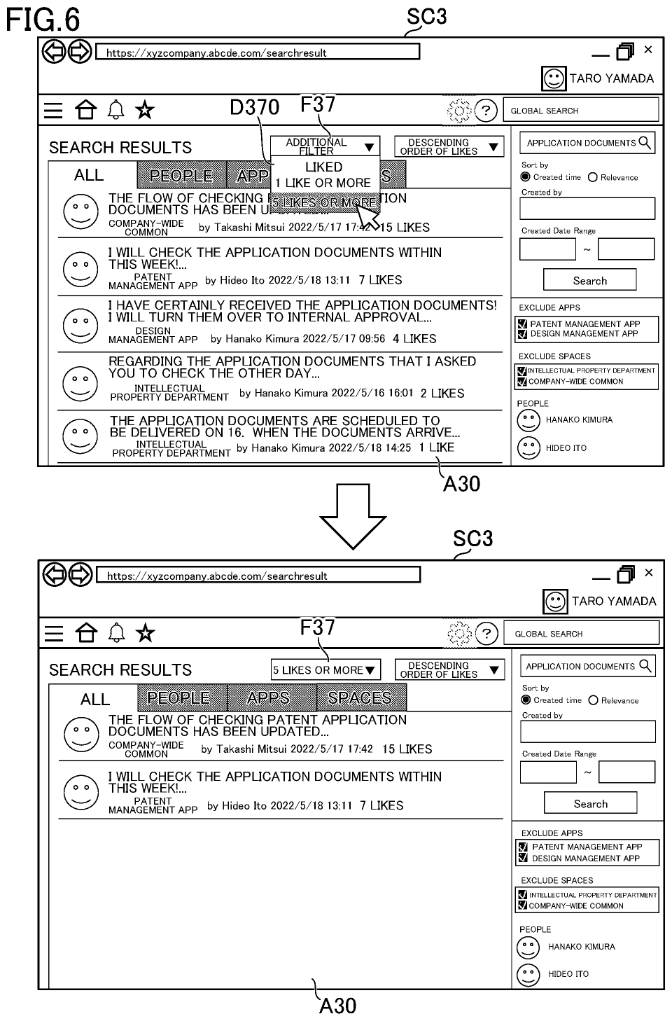

FIG. 5 is a view for illustrating an example of how the sort condition relating to reactions is designated. In FIG. 5, reference symbols that are not referred to are omitted. The same applies to FIG. 6 to FIG. 8 described later. For example, when the user selects the input form F36, a plurality of sort conditions are displayed in a pull-down menu D360. In the example of FIG. 5, three sort conditions such as “POSTED-DATE-AND-TIME ORDER,” “ASCENDING ORDER OF LIKES,” and “DESCENDING ORDER OF LIKES” are displayed in the pull-down menu D360. As described above, “LIKE” is an example of the reaction.

For example, when the user selects “DESCENDING ORDER OF LIKES,” the display of the display area A30 is updated so that individual pieces of data included in the search results are arranged in descending order of the number of reactions. In the example of FIG. 5, five pieces of data having the numbers of reactions of 1, 7, 15, 4, and 2 are shown, and hence the display of the display area A30 is updated so that those five pieces of data are arranged in descending order of the number of reactions. When the user selects “ASCENDING ORDER OF LIKES,” the display of the display area A30 is updated so that those five pieces of data are arranged in ascending order of the number of reactions.

In the at least one embodiment, as a filter condition for data to be included in the search results, it is also possible to designate a condition relating to the reactions to the data. The filter condition is one of search conditions. The filter condition can also be said to be a search query. For example, the user can designate not only a keyword but also a filter condition from an input form F37. In the examples of FIG. 4 and FIG. 5, no filter condition has been designated yet in the input form F37.

FIG. 6 is a view for illustrating an example of how the filter condition relating to reactions is designated. For example, when the user selects the input form F37, a plurality of filter conditions are displayed in a pull-down menu D370. In the example of FIG. 6, three filter conditions such as “LIKED,” “1 LIKE OR MORE,” and “5 LIKES OR MORE” are displayed in the pull-down menu D370. The filter condition “LIKED” means that the user has made his or her own reaction.

For example, when the user selects “5 LIKES OR MORE,” the display of the display area A30 is updated so that data having the number of reactions of five or more is displayed. In the example of FIG. 6, two of the five pieces of data have the number of reactions of five or more, and hence the display of the display area A30 is updated so that those two pieces of data are displayed. When the user selects “LIKED,” the display of the display area A30 is updated so that data to which the user has reacted by himself or herself is displayed. When the user selects “1 LIKE OR MORE,” the display of the display area A30 is updated so that data having the number of reactions of one or more is displayed.

In the examples of FIG. 4 to FIG. 6, a case in which all pieces of data accessible to the user are included in the search range has been described, but in the at least one embodiment, it is possible to switch the search range. The search range is the range of data to be searched. The search range can also be said to be a search population. The search range can also be said to be the range of data to be displayed on the search result screen SC3. For example, a final search range being a final range of searching is identified from checkboxes B38.

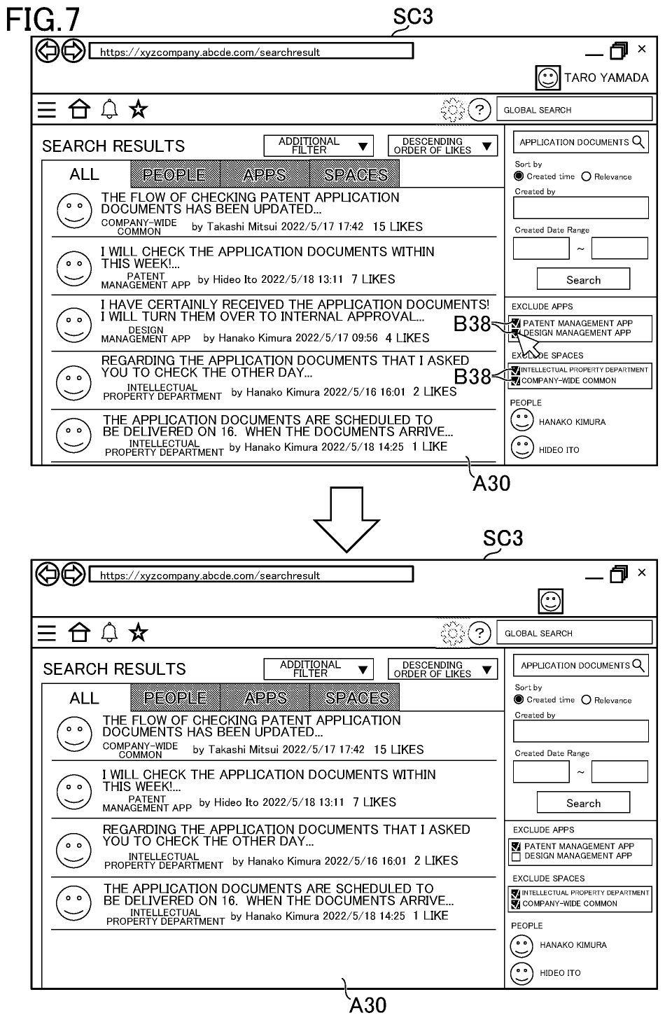

FIG. 7 is a view for illustrating an example of how the final search range is identified from the checkboxes B38. For example, when the user turns off the checkbox B38 for “DESIGN MANAGEMENT APP,” “DESIGN MANAGEMENT APP” is excluded from the search range. Accordingly, as illustrated in FIG. 7, the final search range is identified so that pieces of data on “DESIGN MANAGEMENT APP” are not to be displayed as the search results, and the display of the display area A30 is thus updated.

For example, when the user turns on the checkbox B38 for “DESIGN MANAGEMENT APP,” “DESIGN MANAGEMENT APP” is included in the search range again. In this case, the display of the display area A30 is updated so that pieces of data on “DESIGN MANAGEMENT APP” are displayed as the search results again. The user can switch not only apps but also spaces or other users (“PEOPLE” of FIG. 7 and the like) as the search range. In the at least one embodiment, it is possible to switch the search range also by selecting a tab T39.

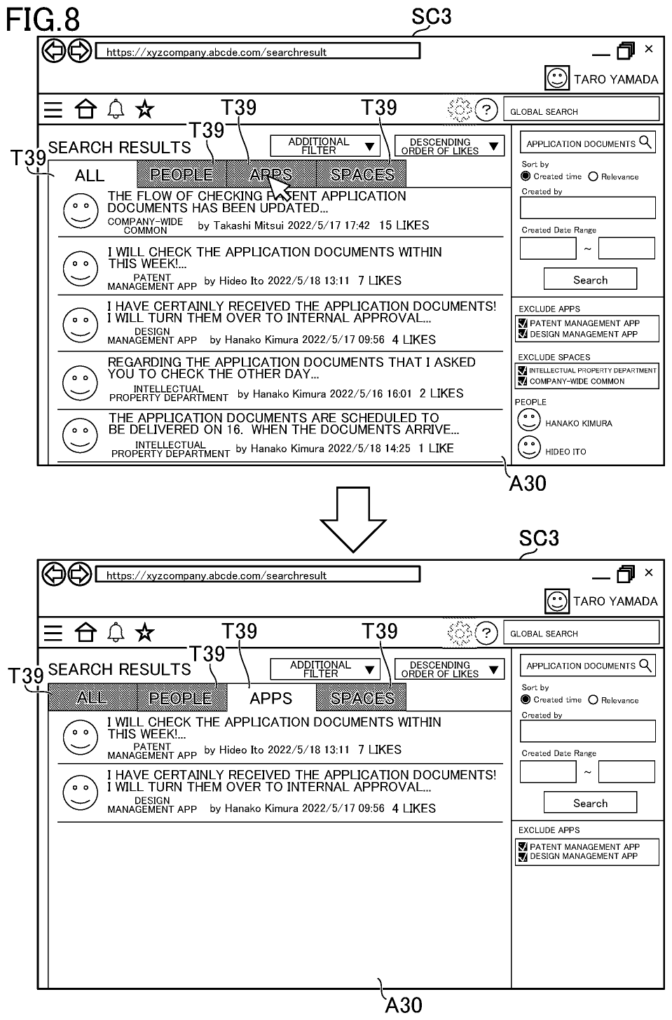

FIG. 8 is a view for illustrating an example of how the search range is switched by the tab T39. For example, when the user selects the tab T39 for “APPS,” the display of the display area A30 is updated so that only pieces of data registered in apps are to be displayed as the search results. For example, when the user selects the tab T39 for “PEOPLE” or “SPACES,” the display of the display area A30 is similarly updated so that only pieces of data registered by other users who have a specific relationship with the user or pieces of data registered in spaces to which the user belongs are displayed as the search results.

As described above, the task support system 1 according to the at least one embodiment displays the search result screen SC3 that increases the convenience of the user on the display unit 25. The search result screen SC3 is designed so as to increase the convenience of the user from various viewpoints, but in the at least one embodiment, a configuration for sorting the search results based on the number of reactions and a configuration for filtering the search results based on the number of reactions are mainly described. Details of the task support system 1 are described below.

[3. Functions Implemented by Task Support System]

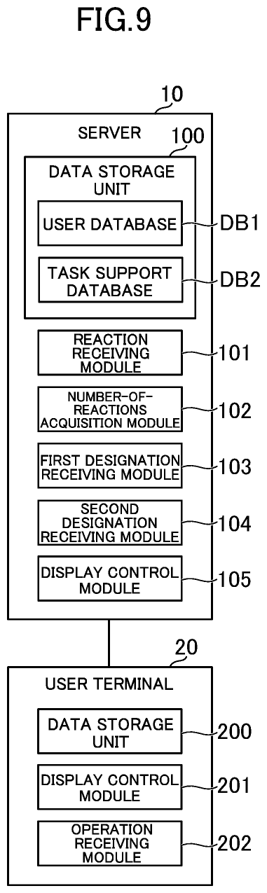

FIG. 9 is a functional block diagram for illustrating functions implemented by the task support system 1. In the at least one embodiment, of the functions implemented by the task support system 1, a function for sorting the search results based on the number of reactions and a function for filtering the search results based on the number of reactions are mainly described.

[3-1. Functions Implemented by Server]

For example, the server 10 includes a data storage unit 100, a reaction receiving module 101, a number-of-reactions acquisition module 102, a first designation receiving module 103, a second designation receiving module 104, and a display control module 105. The data storage unit 100 is implemented by the storage unit 12. The reaction receiving module 101, the number-of-reactions acquisition module 102, the first designation receiving module 103, the second designation receiving module 104, and the display control module 105 are each implemented by the control unit 11.

[Data Storage Unit]

The data storage unit 100 stores data for supporting each of a plurality of users in tasks. For example, the data storage unit 100 stores a user database DB1 and a task support database DB2.

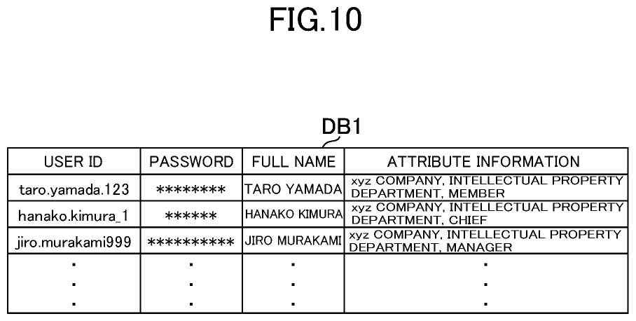

FIG. 10 is a table for showing an example of the user database DB1. The user database DB1 is a database in which various kinds of information relating to users are stored. For example, the user database DB1 stores a user ID, a password, a full name, and attribute information. The user ID is information that can uniquely identify the user. The attribute information is information relating to an attribute of the user. It suffices that the attribute is information that can classify users in some way. For example, the attribute is a group to which the user belongs or a job title of the user.

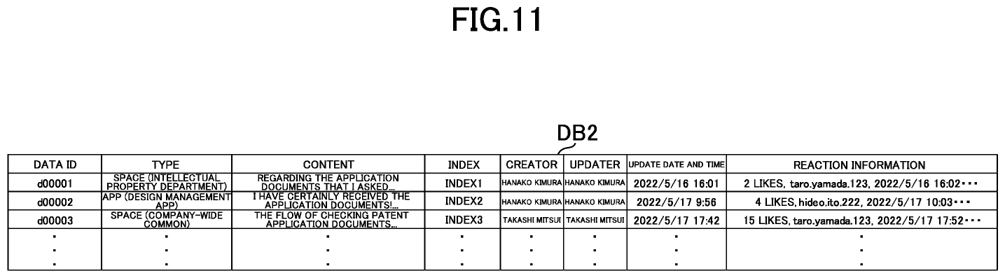

FIG. 11 is a table for showing an example of the task support database DB2. The task support database DB2 is a database in which various kinds of data registered in the task support system 1 are stored. For example, a data ID, a type of data, content of the data, an index to be referred to at a time of searching, a creator of the data, an updater of the data, an update date and time of the data, and reaction information are stored.

The data ID is information that can uniquely identify the data. It may be possible to identify the data not by the data ID but by other information such as a URL for displaying the data. The type of the data is information indicating which of a plurality of functions of the task support system 1 the data relates to. For example, the type of the data indicates whether the data is data registered in a space or data registered in an app. Further, the type of the data may indicate which space the data is registered in or which app the data is registered in.

The content of the data is details of the data. The index is information to be compared to a search condition at the time of searching. The creator of the data is the user ID of the user who created the data. The updater of the data is the user ID of the user who updated the data. The update date and time of the data is the date and time at which the data was most recently updated. The reaction information is information relating to reactions made to the data. For example, the reaction information includes the number of reactions, the user IDs of the users who made the reactions, and the dates and times of the reactions.

The data stored in the data storage unit 100 is not limited to the above-mentioned examples. The data storage unit 100 can store various kinds of data relating to the task support. For example, the data storage unit 100 stores data required for displaying each screen. For example, the data storage unit 100 stores a search engine program.

[Reaction Receiving Module]

The reaction receiving module 101 receives a reaction to each of a plurality of pieces of data registered in the task support system 1. In the at least one embodiment, the reaction receiving module 101 is implemented by the server 10, and hence the reaction receiving module 101 receives a reaction by receiving a predetermined reaction notification from the user terminal 20. The reaction notification is a notification indicating that a reaction has been made to the data.

In the at least one embodiment, the reaction notification is a notification indicating that the icon I200 has been selected. The reaction is only required to be performed by an operation determined in advance, and is not limited to an operation for selecting the icon I200. For example, the reaction may be made by selecting another icon. For example, the reaction may be made by selecting a predetermined key on the keyboard. An operation of inputting a comment as some reply may correspond to the reaction.

For example, the reaction notification includes the data ID of data to which a reaction was made and the user ID of the user who made the reaction. It is assumed that, when data stored in the task support database DB2 is displayed on the user terminal 20, the data ID of the data has also been transmitted to the user terminal 20. This data ID is included in the reaction notification. The user ID included in the reaction notification is the user ID of the user who has logged in when the reaction is made.

For example, when a reaction is made to a comment on a certain app, the user terminal 20 transmits, to the server 10, a reaction notification including the data ID of the comment on the app and the user ID of the user who made the reaction. The reaction receiving module 101 receives the reaction notification, to thereby receive the reaction to the comment. The same applies to reactions to other data different from comments on apps.

For example, the reaction receiving module 101 updates, in the task support database DB2, the reaction information associated with the data ID included in the reaction notification. The reaction receiving module 101 increments the number of reactions indicated by the reaction information to be updated. The reaction receiving module 101 adds, to the reaction information to be updated, the user ID included in the reaction notification and the current date and time as the reaction date and time.

The reaction receiving module 101 may receive cancellation of a reaction made by the user. The reaction may be canceled by any operation. For example, a user who has already made a reaction may cancel the reaction by selecting the icon I200 again. The reaction receiving module 101 may decrement the number of reactions to data for which the reaction has been canceled, and may update the reaction information on the data so that the user ID and the reaction date and time are deleted.

[Number-of-Reactions Acquisition Module]

The number-of-reactions acquisition module 102 acquires the number of reactions to each of a plurality of pieces of data. The number-of-reactions acquisition module 102 can acquire the number of reactions to any piece of data. For example, the number-of-reactions acquisition module 102 acquires the number of reactions to at least one piece of data that satisfies the search conditions designated by the user. The number-of-reactions acquisition module 102 acquires the number of reactions when a condition relating to the number of reactions is designated as the sort condition or the filter condition.

In the at least one embodiment, the number of reactions is indicated in the reaction information of the task support database DB2, and hence the number-of-reactions acquisition module 102 refers to the task support database DB2 to acquire the reaction information associated with data for which the number of reactions is to be acquired, to thereby acquire the number of reactions to the data. The number-of-reactions acquisition module 102 may acquire the number of reactions by aggregating the number of reactions to the data on the spot. The aggregation may be executed by counting the number of user IDs included in the reaction information.

[First Designation Receiving Module]

The first designation receiving module 103 receives designation of any one of a plurality of search ranges. In the at least one embodiment, the first designation receiving module 103 is implemented by the server 10, and hence the first designation receiving module 103 receives a predetermined first designation notification from the user terminal 20, to thereby receive designation of the search range. The first designation notification is a notification indicating that the search range has been designated by the user.

For example, the first designation notification is a notification indicating that the tab T39 has been selected. The designation of the search range is only required to be performed by an operation determined in advance, and is not limited to an operation for selecting the tab T39. For example, the designation of the search range may be an operation for selecting the checkbox B38, or may be performed by selecting some icon or radio button. For example, the designation of the search range may be performed by inputting a character string representing the search range to an input form.

For example, the first designation notification includes information that can identify the designated search range. In the at least one embodiment, the tab T39 for “ALL,” “PEOPLE,” “APPS,” or “SPACES” can be selected, and hence the first designation notification includes information indicating which of those tabs T39 has been selected. For example, when the user selects any one of the tabs T39, the user terminal 20 transmits the first designation notification indicating the selected tab T39 to the server 10. The first designation receiving module 103 receives the first designation notification, to thereby receive the designation of the search range.

[Second Designation Receiving Module]

The second designation receiving module 104 receives designation of at least one of a search range to be set as a search target or a search range to be excluded from search targets from among a plurality of search ranges. In the at least one embodiment, a case in which the second designation receiving module 104 receives designation of both the search range to be set as the search target and the search range to be excluded from the search targets is described, but the second designation receiving module 104 may receive designation of only any one of those search ranges.

In the at least one embodiment, the second designation receiving module 104 is implemented by the server 10, and hence the second designation receiving module 104 receives a predetermined second designation notification from the user terminal 20, to thereby receive the designation of at least one of the search range to be set as the search target or the search range to be excluded from the search targets. The second designation notification is a notification indicating that at least one of the search range to be set as the search target or the search range to be excluded from the search targets has been designated. In the at least one embodiment, the second designation notification is a notification indicating that the checkboxes B38 have been selected.

The designation of at least one of the search range to be set as the search target or the search range to be excluded from the search targets is only required to be performed by the operation determined in advance, and is not limited to an operation for selecting the checkbox B38. For example, the designation of at least one of the search range to be set as the search target or the search range to be excluded from the search targets may be performed by selecting the tab T39, or may be performed by selecting some icon or radio button. For example, a character string representing the search range or a character string representing the search range to be excluded from the search targets may be input to an input form.

For example, turning on the checkbox B38 in an off state corresponds to designating the search range to be set as the search target. Turning off the checkbox B38 in an on state corresponds to designating the search range to be excluded from the search targets. The second designation notification includes information indicating the on or off state of the checkbox B38.

For example, when the user performs an operation on the checkbox B38, the user terminal 20 transmits the second designation notification indicating the on or off state of the checkbox B38 to the server 10. The second designation receiving module 104 receives the second designation notification, to thereby receive the designation of at least one of the search range to be set as the search target or the search range to be excluded from the search targets. The second designation receiving module 104 refers to the on or off state of the checkbox B38 to identify which search range is to be set as the search target or excluded from the search targets.

[Display Control Module]

The display control module 105 displays the search result screen SC3 that shows search results relating to a plurality of pieces of data on the display unit 25 based on the number of reactions to each of the plurality of pieces of data. In the at least one embodiment, a case in which the display control module 105 executes a data search by itself to acquire search results is taken as an example, but the data search may be executed by another functional block different from the display control module 105. For example, another functional block for executing a data search may be present separately from the display control module 105. The display control module 105 may acquire search results executed by another functional block.

For the data search itself, it is possible to use various search methods. In regard to the search engine, it is also possible to use various search engines. For example, the display control module 105 calculates a search score for each individual piece of data based on the search conditions designated by the user and the indices stored in the task support database DB2. The display control module 105 selects a predetermined number (for example, about 10) pieces of data in descending order of the search score, to thereby acquire the search results. The search results include the selected pieces of data. For the search, another method such as character string matching may be used instead of the search score.

In the at least one embodiment, the display control module 105 is implemented by the server 10, and hence the display control module 105 generates display data relating to the search result screen SC3 based on the number of reactions. The display data may be data representing the entire search result screen SC3, or may be data representing only the content of the display area A30. The display control module 105 transmits the generated display data to the user terminal 20, to thereby display the search result screen SC3 on the display unit 25. The display data may have any format, and when, for example, a browser is used, the display data may have an HTML format, or may have another format such as an image format.

In the at least one embodiment, the display control module 105 executes sorting relating to the search results based on the number of reactions to each of the plurality of pieces of data, and displays the search result screen SC3 on the display unit 25. The sorting relating to the search results refers to determining a display order of the plurality of pieces of data included in the search results. The display control module 105 executes the sorting based on the number of reactions to each of the plurality of pieces of data included in the search results.

For example, when the user selects “ASCENDING ORDER OF LIKES” from the pull-down menu D360 of the input form F36, the display control module 105 displays, on the display unit 25, the search result screen SC3 on which the plurality of pieces of data included in the search results are arranged in ascending order of the number of reactions. When the user selects “DESCENDING ORDER OF LIKES” from the pull-down menu D360 of the input form F36, the display control module 105 displays, on the display unit 25, the search result screen SC3 on which the plurality of pieces of data included in the search results are arranged in descending order of the number of reactions.

In the at least one embodiment, the display control module 105 executes filtering relating to the search results based on the number of reactions to each of the plurality of pieces of data, and displays the search result screen SC3 on the display unit 25. The filtering relating to the search results refers to narrowing down data to be actually displayed from among the plurality of pieces of data included in the search results. Through the filtering, only some of the plurality of pieces of data that satisfy the search conditions are displayed. For example, the filtering may be executed so that only pieces of data having the number of reactions equal to or larger than a predetermined threshold are displayed. The filter condition can also be regarded as one of the search conditions, and hence in this case, the filtering corresponds to narrowing down data to be actually displayed from among the plurality of pieces of data that satisfy the other search conditions.

For example, when the user selects “1 LIKE OR MORE” from the pull-down menu D370 of the input form F37, the display control module 105 displays, on the display unit 25, the search result screen SC3 that shows only pieces of data having the number of reactions equal to or larger than one from among the plurality of pieces of data that satisfy the search conditions. When the user selects “5 LIKES OR MORE” from the pull-down menu D370 of the input form F37, the display control module 105 displays, on the display unit 25, the search result screen SC3 that shows only pieces of data having the number of reactions equal to or larger than five from among the plurality of pieces of data that satisfy the search conditions. The threshold value is not limited to one or five as in the at least one embodiment, and may be any value such as 2 to 4 or 6 or more.

The filtering is not limited to a method using a threshold determined in advance. For example, the display control module 105 may execute the filtering so that, among the plurality of pieces of data included in the search results, only a predetermined number of pieces of data (for example, only the top three pieces of data) are displayed in descending order of the number of reactions. For example, the display control module 105 may execute the filtering so that, among the plurality of pieces of data included in the search results, only pieces of data having the number of reactions larger than an average value of those of the plurality of pieces of data are displayed.

In the at least one embodiment, the display control module 105 executes the filtering so that, among the plurality of pieces of data, at least one piece of data to which a specific user has reacted remains, and displays the search result screen SC3 on the display unit 25 based on an execution result of the filtering. The specific user is any one of a plurality of users who can react to the data. The specific user may be a user determined in advance, or may be a user designated on the search result screen SC3.

In the at least one embodiment, a case in which the user (that is, himself or herself) displaying the search result screen SC3 corresponds to the specific user is taken as an example, but the specific user may be another user. For example, the specific user may be a superior of the user displaying the search result screen SC3, or may be a co-worker in the same department. The specific user may be another user designated in advance by the user displaying the search result screen SC3.

For example, when the user selects “LIKED” from the pull-down menu D370 of the input form F37, the display control module 105 displays, on the display unit 25, the search result screen SC3 that shows only at least one piece of data to which the user himself or herself has reacted from among the plurality of pieces of data included in the search results. The display control module 105 refers to the reaction information on each of the plurality of pieces of data included in the search results to identify data for which the user ID of the user displaying the search result screen SC3 is indicated, as the data to which the user himself or herself has reacted.

In the at least one embodiment, after the display control module 105 acquires the search results, the display control module 105 classifies the search results based on the search range, and displays, on the display unit 25, the search result screen SC3 that shows the classified search results based on the designated search range (search range received by the first designation receiving module 103). For example, the display control module 105 temporarily searches all the search targets for at least one piece of data that satisfies the search conditions. A search method to be used therefor is as described above.

For example, the search range is designated when the user selects the tab T39 after the above-mentioned temporary search results are acquired. The display control module 105 classifies the search results so that the designated search range remains from all the search results. The display control module 105 displays, on the display unit 25, the search result screen SC3 that shows the classified search results. For example, when the user selects the tab T39 for “PEOPLE,” the display control module 105 classifies the search results so that pieces of data registered by other users who have a specific relationship with the user remain. In this case, pieces of data registered by other users who do not have a specific relationship with the user are not to be displayed in the display area A30.

For example, when the user selects the tab T39 for “APPS,” the display control module 105 classifies the search results so that pieces of data registered in apps remain. In this case, pieces of data (for example, thread data in spaces) other than those in apps are not to be displayed in the display area A30. For example, when the user selects the tab T39 for “SPACES,” the display control module 105 classifies the search results so that pieces of data registered in spaces remain. In this case, pieces of data (for example, data registered in apps) other than those in spaces are not to be displayed in the display area A30.

For example, the display control module 105 identifies, based on the designation received by the second designation receiving module 104, the final search range to be finally set as the search target, and displays, on the display unit 25, the search result screen SC3 that shows the search results within the identified final search range. The final search range is a search range to be displayed on the search result screen SC3 after the second designation receiving module 104 receives the designation. The display control module 105 displays the search result screen SC3 on the display unit 25 so that at least one piece of data that satisfies the search conditions is included in the search results within the final search range designated as the search target. The display control module 105 displays the search result screen SC3 on the display unit 25 so that pieces of data excluded from the search targets are not included in the search results.

For example, when the user turns off the checkbox B38 for a certain app, the display control module 105 controls the display of the search result screen SC3 so that pieces of data registered in the certain app are not displayed as the search results. When the user turns on the checkbox B38 for a certain app, the display control module 105 controls the display of the search result screen SC3 so that pieces of data registered in the certain app are displayed as the search results.

For example, when the user turns off the checkbox B38 for a certain space, the display control module 105 controls the display of the search result screen SC3 so that pieces of data registered in the certain space are not displayed as the search results. When the user turns on the checkbox B38 for a certain space, the display control module 105 controls the display of the search result screen SC3 so that pieces of data registered in the certain space are displayed as the search results. The display control module 105 may control the display of the search result screen SC3 in the same manner when a search range other than that for an app or a space is designated.

[3-2. Functions Implemented by User Terminal]

For example, the user terminal 20 includes a data storage unit 200, a display control module 201, and an operation receiving module 202. The data storage unit 200 is implemented by the storage unit 22. The display control module 201 and the operation receiving module 202 are each implemented by the control unit 21.

[Data Storage Unit]

The data storage unit 200 stores data required for supporting the users in tasks. For example, the data storage unit 200 stores a browser for displaying various screens relating to the task support system 1. For example, the data storage unit 200 stores an application dedicated to the task support system 1. For example, the data storage unit 200 stores details of input to the search result screen SC3.

[Display Control Module]

The display control module 201 displays various screens relating to the task support system 1 on the display unit 25. For example, the display control module 201 displays, on the display unit 25, the portal screen SC1, the space screen SC2, or the search result screen SC3 based on the display data received from the server 10.

[Operation Receiving Module]

The operation receiving module 202 receives various operations in the task support system 1. For example, the operation receiving module 202 receives an operation performed on the search result screen SC3. Details of the operation received by the operation receiving unit 202 are transmitted to the server 10 as appropriate.

[4. Processing to be Executed by Task Support System]

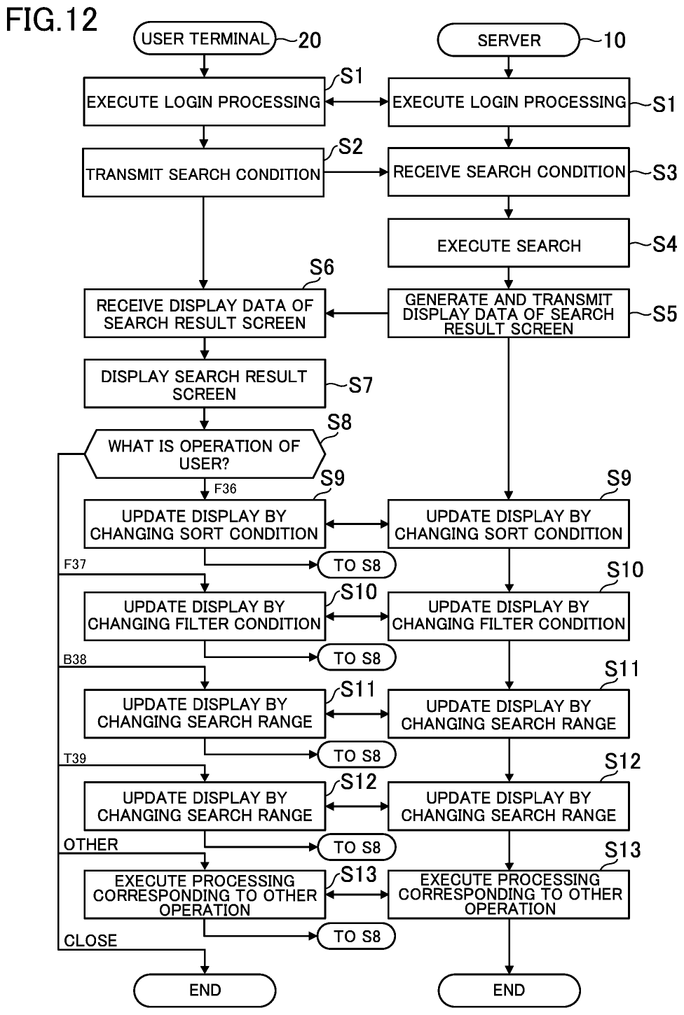

FIG. 12 is a flow chart for illustrating an example of processing to be executed by the task support system 1. Of different kinds of processing to be executed by the task support system 1, processing relating to the display of the search result screen SC3 is mainly described with reference to FIG. 12.

As illustrated in FIG. 12, login processing for causing a user to log in to the task support system 1 is executed between the server 10 and the user terminal 20 (Step S1). In Step S1, the user terminal 20 transmits, to the server 10, the user ID and the password that have been input by the user. The server 10 refers to the user database DB1 to verify validity of the user ID and the password. When the login processing is successful, the portal screen SC1 is displayed on the display unit 25. After that, the server 10 becomes able to identify which user has performed an operation such as a reaction.

When the portal screen SC1 is displayed on the display unit 25 in Step S1, the user can use various functions provided by the task support system 1. For example, the user accesses data in apps, threads, or the like that is allowed to be viewed by himself or herself. The user can also leave reactions to data. For example, when the user leaves a reaction to a certain piece of data by selecting the icon I200, the server 10 updates the task support database DB2 so that the reaction information associated with the data ID of the certain piece of data is updated.

Processing relating to the data search is described below. In this case, processing to be executed when a search condition is input to the input form F12 of the portal screen SC1 is described. For example, the user terminal 20 transmits, to the server 10, the search condition that has been input to the input form F12 (Step S2). When the server 10 receives the search condition (Step S3), the server 10 executes a search based on the task support database DB2 and the received search condition (Step S4).

In Step S4, the server 10 searches pieces of data stored in the task support database DB2 for a predetermined number of pieces of data that satisfy the search condition based on the indices associated with pieces of data within the search range. In this case, a case in which all pieces of data accessible to the user are set as the search range is described, but only a part of the data such as a specific space or app may be set as the search range. The server 10 acquires the predetermined number of pieces of data that satisfy the search condition as the search results.

The server 10 generates display data of the search result screen SC3 based on the search results obtained in Step S4, and transmits the display data to the user terminal 20 (Step S5). In Step S5, the server 10 arranges, in the display area A30, a predetermined number of pieces of data included in the search results based on a default sort condition (for example, posted-date-and-time order). The server 10 also determines other parts of the search result screen SC3 so that the other parts have default details, generates display data of the search result screen SC3, and transmits the display data to the user terminal 20.

When the user terminal 20 receives the display data of the search result screen SC3 (Step S6), the user terminal 20 displays the search result screen SC3 on the display unit 25 (Step S7). The user terminal 20 identifies an operation of the user performed on the search result screen SC3 based on a detection signal from the operating unit 24 (Step S8). In Step S8, it is assumed that an operation on the input form F36, an operation on the input form F37, an operation on the checkboxes B38, an operation on the tab T39, an operation for closing the search result screen SC3, and another operation is performed.

In Step S8, when an operation on the input form F36 is performed (“F36” in Step S8), the user terminal 20 cooperates with the server 10 to execute processing for updating the display of the search result screen SC3 by changing the sort condition (Step S9), and the process returns to the processing step of Step S8. In Step S9, the user terminal 20 transmits a predetermined sort condition change notification. The sort condition change notification is a notification indicating that the sort condition has been changed. The sort condition change notification includes information that can identify the sort condition input to the input form F36.

In Step S9, when the server 10 receives the sort condition change notification, the server 10 executes the sorting relating to the search results based on the sort condition included in the sort condition change notification. The server 10 generates display data of the search result screen SC3 based on an execution result of the sorting, and transmits the display data to the user terminal 20. When the user terminal 20 receives the display data of the search result screen SC3, the user terminal 20 updates the display of the search result screen SC3.

In Step S8, when an operation on the input form F37 is performed (“F37” in Step S8), the user terminal 20 cooperates with the server 10 to execute processing for updating the display of the search result screen SC3 by changing the filter condition (Step S10), and the process returns to the processing step of Step S8. In Step S10, the user terminal 20 transmits a predetermined filter condition designation notification. The filter condition designation notification is a notification indicating that the filter condition has been designated. The filter condition designation notification includes information that can identify the filter condition input to the input form F37.

In Step S10, when the server 10 receives the filter condition designation notification, the server 10 executes the filtering relating to the search results based on the filter condition included in the filter condition designation notification. The server 10 generates display data of the search result screen SC3 based on an execution result of the filtering, and transmits the display data to the user terminal 20. When the user terminal 20 receives the display data of the search result screen SC3, the user terminal 20 updates the display of the search result screen SC3.

In Step S8, when an operation on the checkbox B38 is performed (“B38” in Step S8), the user terminal 20 cooperates with the server 10 to execute processing for updating the display of the search result screen SC3 by changing the search range in accordance with the checkbox B38 (Step S11), and the process returns to the processing step of Step S8. In Step S11, the user terminal 20 transmits the first designation notification including information that can identify the search range designated by turning on or off the checkbox B38.

In Step S11, when the server 10 receives the first designation notification, the server 10 classifies the executed search results for all the search ranges based on the search range included in the first designation notification. That is, the server 10 executes the filtering so that, among temporarily executed search results for all the pieces of data, only those within the search range designated by the user remain. The server 10 generates display data of the search result screen SC3 and transmits the display data to the user terminal 20. When the user terminal 20 receives the display data of the search result screen SC3, the user terminal 20 updates the display of the search result screen SC3.

In Step S8, when an operation on the tab T39 is performed (“T39” in Step S8), the user terminal 20 cooperates with the server 10 to execute processing for updating the display of the search result screen SC3 by changing the search range in accordance with the tab T39 (Step S12), and the process returns to the processing step of Step S8. In Step S12, the user terminal transmits the second designation notification including information that can identify the search range corresponding to the selected tab T39.

In Step S12, when the server 10 receives the second designation notification, the server 10 classifies the executed search results for all the search ranges based on the search range included in the second designation notification. That is, the server 10 executes the filtering so that, among temporarily executed search results for all the pieces of data, only those within the search range designated by the user remain. The server 10 generates display data of the search result screen SC3 and transmits the display data to the user terminal 20. When the user terminal 20 receives the display data of the search result screen SC3, the user terminal 20 updates the display of the search result screen SC3.

In Step S8, when another operation is performed (“OTHER” in Step S8), the user terminal 20 cooperates with the server 10 to execute processing corresponding to the other operation performed by the user (Step S13), and the process returns to the processing step of Step S8. The other operation is, for example, an operation for further displaying search results that were not able to be fully displayed in the display area A30. The server may update the display of the search result screen SC3 based on the other operation. When an operation for closing the search result screen SC3 is performed in Step S8 (“CLOSE” in Step S8), this process is ended.

The task support system 1 according to the at least one embodiment displays, on the display unit 25, the search result screen SC3 that shows the search results relating to the plurality of pieces of data based on the number of reactions to each of the plurality of pieces of data registered in the task support system 1. This enables the number of reactions to the data to be reflected in the display of the search result screen SC3, thereby increasing the convenience of the user in the task support system 1 that allows a reaction to be made to data. For example, the user can enhance usability of the search result screen SC3 by executing the sorting of the search results based on the number of reactions or the filtering of the search results based on the number of reactions, thereby increasing the convenience of the user.

Further, the task support system 1 executes the sorting relating to the search results based on the number of reactions to each of the plurality of pieces of data, and displays the search result screen SC3 on the display unit 25. This enables the user to intuitively grasp which piece of data in the search results has a large number of reactions made thereto or has a small number of reactions made thereto. For example, it is possible to preferentially display more important pieces of data having a larger number of reactions by sorting the search results in descending order of the number of reactions, thereby increasing the convenience of the user. In contrast, it is possible to preferentially display pieces of data having a smaller number of reactions, which are likely to have been unnoticed by the user, by sorting the search results in ascending order of the number of reactions, thereby increasing the convenience of the user.

Further, the task support system 1 executes the filtering relating to the search results based on the number of reactions to each of the plurality of pieces of data, and displays the search result screen SC3 on the display unit 25. This enables only pieces of data having the number of reactions within a predetermined number or range to be displayed on the search result screen SC3, and hence it becomes easier for the user to search for data desired by the user. For example, when the user wishes to search for more important pieces of data having a larger number of reactions, the filtering is executed so that only pieces of data having the number of reactions equal to or larger than a certain threshold value are displayed, and hence it becomes easier for the user to search for pieces of data having a larger number of reactions. In contrast, the filtering is executed so that only pieces of data having a smaller number of reactions, which are likely to have been unnoticed by the user, are displayed, and hence it becomes easier for the user to search for pieces of data having a smaller number of reactions.

Further, the task support system 1 executes the filtering so that at least one piece of data to which a specific user has reacted remains, and displays the search result screen SC3 on the display unit 25 based on an execution result of the filtering. Thus, it becomes easier for the user to search for the pieces of data to which the specific user has reacted. For example, when the user who displays the search result screen SC3 is set as the specific user, the user can search for the pieces of data to which the user himself or herself has reacted, similarly to a case of using a bookmark. In this case, it is not required to provide a bookmark operation separately from the reaction for leaving a like, an emoji, or the like. For example, when the superior of the user is set as the specific user, it becomes easier for the user to search for pieces of data to which the superior has reacted.

Further, after the task support system 1 acquires the search results, the task support system 1 classifies the search results based on the search range, and displays, on the display unit 25, the search result screen SC3 that shows the classified search results based on the search range designated by the checkbox B38 or the tab T39. Thus, the search results are classified after a temporary search for all the search ranges has been executed, and hence it is not required to execute the search again, thereby alleviating a processing load on the server 10. It is also possible to shorten a time period required for the display of the search result screen SC3.

Further, the task support system 1 identifies the final search range to be finally set as the search target from among a plurality of search ranges based on the designation of at least one of the search range to be set as the search target or the search range to be excluded from the search targets, and displays, on the display unit 25, the search result screen SC3 that shows the search results within the identified final search range. This enables the user to easily switch the final search range, thereby increasing the convenience of the user.

[5. Modification Examples]

The present disclosure is not limited to the examples of the at least one embodiment described above, and can be modified suitably without departing from the spirit of the present disclosure.

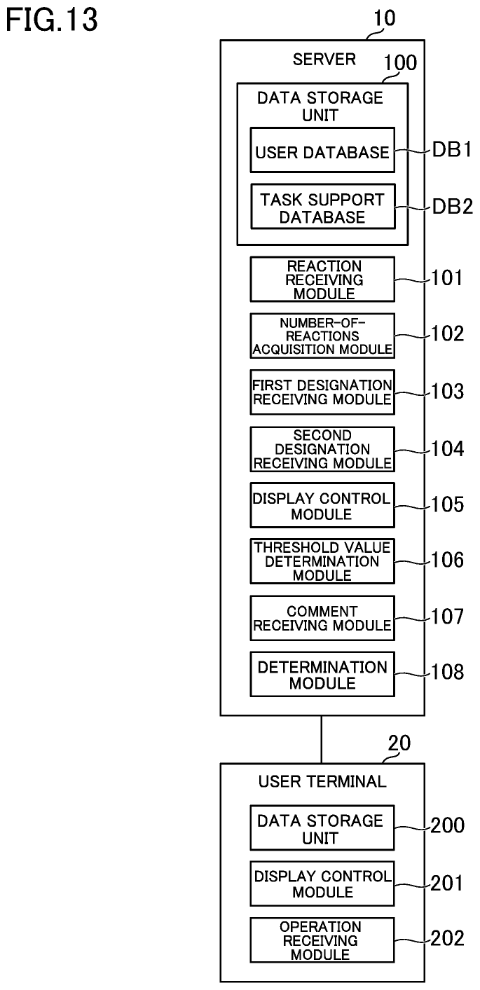

FIG. 13 is a diagram for illustrating an example of functional blocks in modification examples. For example, the server 10 includes a threshold value determination module 106, a comment receiving module 107, and a determination module 108. The threshold value determination module 106, the comment receiving module 107, and the determination module 108 are each implemented by the control unit 11.

[5-1. Modification Example 1]

For example, in the at least one embodiment, a case in which the threshold value for the filtering relating to the number of reactions is fixed has been described, but the threshold value may be variable. For example, data accessible to a user who works for a large company tends to have a larger number of reactions than that of data accessible to a user who works for a small-to-medium company. Thus, the threshold value may be determined so that the threshold value for the user who works for a large company is higher than the threshold value for the user who works for a small-to-medium company.

The task support system 1 according to Modification Example 1 includes the threshold value determination module 106. The threshold value determination module 106 determines a threshold value relating to filtering based on a group to which a user for which the search result screen SC3 is to be displayed on the display unit 25 belongs. The user is a user who has logged in to the task support system 1. In other words, the user is a user who has requested the display of the search result screen SC3. It is assumed that the server 10 receives the user ID of the user or other information that can identify the user at a time of performing some communication to/from the user terminal 20.

It is assumed that relationships between conditions relating to groups and threshold values are defined in advance in the data storage unit 100. Those relationships can be defined in any format. For example, those relationships may be defined in data having a table format, data having a mathematical expression format, or a part of program code. The threshold value determination module 106 determines a threshold value associated with a condition satisfied by a group to which a certain user belongs as a threshold value to be applied to the certain user.

For example, the threshold value determination module 106 refers to the user database DB1 to identify the group to which the user belongs. The threshold value determination module 106 determines the threshold value so that the threshold value becomes higher as the number of people in the group to which the user belongs becomes larger. That is, the threshold value determination module 106 determines the threshold value so that the threshold value becomes lower as the number of people in the group to which the user belongs becomes smaller. The numbers of people in groups may be stored in the user database DB1, or may be stored in another database.

A method by which the threshold value determination module 106 determines the threshold value is not limited to a method using the number of people in the group. The threshold value determination module 106 is only required to determine the threshold value through use of the group to which the user belongs in some way. For example, the threshold value determination module 106 may refer to the task support database DB2 to calculate an average value of the numbers of reactions in the group to which the user belongs, and may determine the threshold value to be applied to the group based on the average value. In this case, the threshold value determination module 106 may determine the average value as the threshold value as it is, or may determine a value obtained by increasing or decreasing the average value as the threshold value.

The display control module 105 executes the filtering based on the threshold value determined by the threshold value determination module 106. Modification Example 1 differs from the at least one embodiment in that the threshold value determined by the threshold value determination module 106 is used, but the processing itself for executing the filtering based on the threshold value is the same as in the at least one embodiment.

The task support system 1 according to Modification Example 1 determines the threshold value relating to the filtering based on the group to which the user for which the search result screen SC3 is to be displayed on the display unit 25 belongs. This enables flexible filtering to be performed depending on the user, thereby increasing the convenience of the user. For example, in a case of the user who works for a large company, when the threshold value is small, almost all pieces of data may be displayed with no substantial filtering. In this case, the threshold value is set higher, to thereby enable effective filtering specific to large companies. In contrast, in a case of the user who works for a small-to-medium company, when the threshold value is large, almost all pieces of data may not be displayed. In this case, the threshold value is set lower, to thereby enable effective filtering specific to small-to-medium companies.

[5-2. Modification Example 2]

For example, in the at least one embodiment, when the user selects the checkbox B38 or the tab T39 to designate the search range after a temporary search for all the search ranges has been executed, the search results are classified based on the designated search range. In Modification Example 2, a case in which a search is executed for each of search ranges that can be designated by the user at a time point of executing the first search is described.

The display control module 105 in Modification Example 2 acquires search results for each search range based on each of a plurality of search ranges, and displays, on the display unit 25, the search result screen SC3 that shows the search results corresponding to the search range designated from among the plurality of search ranges. The plurality of search ranges are all or some of the search ranges that can be designated by the user. The display control module 105 acquires in advance the search results for the plurality of search ranges, and displays, on the search result screen SC3, the search results corresponding to the search range actually designated by the user.

On the search result screen SC3 of FIG. 4 to FIG. 8, for example, the on or off state of the search range for each app or space can be designated by the checkbox B38. Thus, the display control module 105 acquires search results for each combination of apps or spaces that can be designated as the search range through use of the checkboxes B38. The display control module 105 displays, on the search result screen SC3, the search results corresponding to the on or off states of the checkboxes B38 among the search results acquired for the respective combinations.

In the examples of FIG. 4 to FIG. 8, in regard to combinations of apps, there are three patterns of only “PATENT MANAGEMENT APP,” only “DESIGN MANAGEMENT APP,” and both thereof. In regard to combinations of spaces, there are three patterns of only “INTELLECTUAL PROPERTY DEPARTMENT,” only “COMPANY-WIDE COMMON,” and both thereof. Thus, the display control module 105 acquires in advance the search results for a total of six search ranges. It is assumed that the search results for the respective search ranges are held in the data storage unit 100. When the user designates a search range, the display control module 105 reads out the search results corresponding to the search range designated by the user from among the search results for the held search ranges. The display control module 105 displays, on the search result screen SC3, the search results corresponding to the on or off states of the checkboxes B38 among those six patterns.

In the examples of FIG. 4 to FIG. 8, it is possible to switch the search range not only by the checkbox B38 but also by the tab T39. Thus, the display control module 105 acquires search results for each of search ranges that can be designated through use of the tab T39. In the examples of FIG. 4 to FIG. 8, it is possible to designate three search ranges for “PEOPLE,” “APPS,” and “SPACES.” Thus, the display control module 105 acquires in advance the search results for those three search ranges. The display control module 105 displays, on the search result screen SC3, the search result corresponding to the tab T39 selected by the user among those three patterns.

The task support system 1 according to Modification Example 2 acquires the search results for each search range based on each of a plurality of search ranges, and displays, on the display unit 25, the search result screen SC3 that shows the search results corresponding to the search range designated from among the plurality of search ranges. Thus, the search results for each search range are acquired in advance, and hence the user is not required to perform a search or classify the search results after designating the search range, thereby being able to shorten the time period required for the display of the search result screen SC3.

[5-3. Modification Example 3]

For example, in the examples of FIG. 4 to FIG. 8, data registered in the “COMPANY-WIDE COMMON” space is data targeted for all employees, and hence more users are expected to react thereto than to data registered in the space for “INTELLECTUAL PROPERTY DEPARTMENT.” For that reason, more reactions tend to be left to the data registered in the “COMPANY-WIDE COMMON” space than for the data registered in the space for “INTELLECTUAL PROPERTY DEPARTMENT.” In this case, when the sorting or the filtering is executed simply based on the number of reactions, the data registered in the “COMPANY-WIDE COMMON” space is more preferentially displayed than the data registered in the space for “INTELLECTUAL PROPERTY DEPARTMENT,” and the data registered in the space for “INTELLECTUAL PROPERTY DEPARTMENT” may be liable to get buried.

In view of this, the display control module 105 in Modification Example 3 displays the search result screen SC3 on the display unit 25 based on the number of reactions to each of a plurality of pieces of data and the number of users who are expected to react to the piece of data. Being expected to react refers to being likely to react by being included in a predetermined condition. For example, the user who is expected to react to a piece of data is a user who is allowed to view the piece of data, a user who has actually viewed the piece of data, a user who has joined a specific group (in FIG. 2, space) in a case in which all the users are allowed to view the piece of data, or a user included in a notification called a mention.

In Modification Example 3, the user who is allowed to view a piece of data is described as an example of the user who is expected to react to the piece of data. For example, the number of users who are allowed to view the piece of data is the number of users who have access authority to the piece of data. It is assumed that the access authority to data is defined in the task support database DB2. The display control module 105 aggregates the numbers of users who have access authority to individual pieces of data, and identifies each number as the number of users who are allowed to view each piece of data. It is assumed that the number of users who are allowed to view a piece of data includes not only the user who has actually viewed the piece of data but also a user who is allowed to view but has not viewed the piece of data. Even when the user who is expected to react to a piece of data has another meaning, the numbers of users who are expected to react to pieces of data may be aggregated based on a predetermined aggregation method.

For example, the display control module 105 divides the number of reactions to each of the plurality of pieces of data by the number of users who are expected to react to the piece of data (for example, the number of users who are allowed to view the piece of data), to thereby calculate a probability of the reaction to the piece of data. The display control module 105 displays the search result screen SC3 on the display unit 25 based on the probability of the reaction to each of the plurality of pieces of data.

For example, the display control module 105 executes the sorting relating to the search results based on the probability of the reaction, and displays the search result screen SC3 on the display unit 25. When “ASCENDING ORDER OF LIKES” is selected from the pull-down menu D360 of the input form F36, the display control module 105 sorts the search results in ascending order of the probability of the reaction, and displays the search result screen SC3 on the display unit 25. When “DESCENDING ORDER OF LIKES” is selected from the pull-down menu D360 of the input form F36, the display control module 105 sorts the search results in descending order of the probability of the reaction, and displays the search result screen SC3 on the display unit 25.

For example, the display control module 105 executes the filtering relating to the search results based on the probability of the reaction, and displays the search result screen SC3 on the display unit 25. In Modification Example 3, a threshold value relating to the probability of the reaction can be designated from the pull-down menu D370 of the input form F37. For example, when “LIKE RATE OF 20% OR HIGHER” is selected from the pull-down menu D370, the display control module 105 filters the search results so that only pieces of data having the probability of the reaction equal to or higher than 20%, and displays the search result screen SC3 on the display unit 25. It may be possible to designate any other probability as the threshold value from the pull-down menu D370.

Instead of calculating the probability of the reaction, the display control module 105 may correct the number of reactions to each of the plurality of pieces of data based on the number of users who are expected to react to the piece of data, to thereby calculate the final number of reactions to the piece of data. It is assumed that a relationship between the number of users who are expected to react to the piece of data and an amount of the correction is stored in advance in the data storage unit 100. The relationship may be data having any format, for example, may be data having a table format, data having a mathematical expression format, or a part of program code.

For example, the display control module 105 corrects the number of reactions to each of the plurality of pieces of data based on the amount of the correction associated with the number of users who are expected to react to the piece of data, to thereby calculate the final number of reactions to the piece of data. The display control module 105 may perform the correction so that the final number of reactions becomes smaller than the original number thereof as the number of users who are expected to react to the piece of data becomes larger. That is, the display control module 105 may perform the correction so that the final number of reactions becomes larger than the original number thereof as the number of users who are expected to react to the piece of data becomes smaller.

The task support system 1 according to Modification Example 3 displays the search result screen SC3 on the display unit 25 based on the number of reactions to each of the plurality of pieces of data and the number of users who are expected to react to the piece of data. Thus, it is possible to prevent pieces of data having a relatively small number of users who are expected to react thereto from being buried under the search result screen SC3.

[5-4. Modification Example 4]

For example, when it is possible to input a comment on a certain piece of data, it may be considered that the user has substantially taken an action equivalent to a reaction such as a like depending on a detail of the comment. For example, when another user B inputs a comment such as “That idea is great!” on a post made by a certain user A without selecting the icon I200 therefor, inputting the comment by the user B is considered to have a meaning equivalent to substantially selecting the icon I200. In this case, even when the user B does not select icon I200, the number of reactions may be incremented.

The task support system 1 according to Modification Example 4 includes the comment receiving module 107 and the determination module 108. The comment receiving module 107 can receive a comment on each of the plurality of pieces of data as a reaction. The reaction receiving module 101 in Modification Example 4 receives a reaction other than a comment (for example, selection of the icon I200). The comment is sometimes called a message. The comment contains a character string. An operation amount required for inputting a comment is larger than an operation amount required for a reaction. For example, the reaction described in the at least one embodiment can be completed with one click or tap, but inputting a comment requires two or more times of inputting a character. It is assumed that information that can identify which piece of data a certain comment has been left for is stored in the task support database DB2.

In Modification Example 4, the comment receiving module 107 is implemented by the server 10, and hence the comment receiving module 107 receives the input of a comment by receiving a predetermined comment input notification from the user terminal 20. The comment input notification is a notification that a comment has been input by the user. The comment input notification includes the user ID of the user who has input the comment and the detail of the comment. In the example of FIG. 3, when the user selects an icon I201, an input form for a comment on the post is displayed. The user inputs a comment from the input form.

When the user who has input a comment on each of a plurality of pieces of data has not made a reaction other than the comment to the piece of data, the determination module 108 determines whether or not the comment contains a detail equivalent to a reaction other than the comment. It is assumed that predetermined expressions representing details equivalent to reactions are defined in advance in the data storage unit 100. For example, the predetermined expressions are expressions such as “GREAT,” “GOOD,” “NICE,” or “EXCELLENT.” Not only expressions having meanings positive about pieces of data registered by other users but also expressions having negative meanings may be registered in the data storage unit 100 as the predetermined expressions.

For example, the determination module 108 determines whether or not a comment on each individual piece of data contains a predetermined expression. When a comment input by a certain user does not contain a predetermined expression, the determination module 108 does not determine that the comment contains a detail equivalent to a reaction. When the comment input by the certain user contains a predetermined expression, the determination module 108 determines that the comment contains a detail equivalent to a reaction.

The number-of-reactions acquisition module 102 in Modification Example 4 acquires the number of reactions based on a determination result obtained by the determination module 108. For example, when the number-of-reactions acquisition module 102 does not determine that the comment input by the certain user contains a detail equivalent to a reaction, the number-of-reactions acquisition module 102 does not increment the number of reactions, and when the number-of-reactions acquisition module 102 determines that the comment input by the certain user contains a detail equivalent to a reaction, the number-of-reactions acquisition module 102 increments the number of reactions. The number-of-reactions acquisition module 102 updates not only the number of reactions but also the user ID and the reaction date and time in the reaction information. A display method for the search result screen SC3 may be the same as in the at least one embodiment.

The task support system 1 according to Modification Example 4 acquires the number of reactions based on the determination result of whether or not a comment contains a detail equivalent to a reaction other than the comment. Thus, for example, not only the selection of the icon I200 but also the detail of a comment can be taken into consideration, and hence a reaction to data made by the user can be determined more accurately.

[5-5. Modification Example 5]

For example, in the at least one embodiment, one type of operation for selecting the icon I200 has been described as an example of the reaction, but the reaction receiving module 101 may be able to receive each of a plurality of types of reactions. In Modification Example 5, a case in which another icon such as “LOVE” can be selected separately from the icon I200 is taken as an example. As the type of reaction itself, any type may be used, for example, not only positive reactions but also negative reactions may be possible. There may be three or more types of reactions.

The number-of-reactions acquisition module 102 in Modification Example 5 acquires, based on types of reactions to each of a plurality of pieces of data, the numbers of reactions to the piece of data. It is assumed that a relationship between the type of reaction and the number of reactions is stored in advance in the data storage unit 100. The relationship may have any format, for example, may have a table format, have a mathematical expression format, be or a part of program code. The number-of-reactions acquisition module 102 acquires the number of reactions associated with the type of each reaction to a certain piece of data.

For example, it is assumed that, when the icon I200 is selected, the number of reactions is incremented by one. It is assumed that, when another icon for “LOVE” is selected, the number of reactions is incremented by 10. The number-of-reactions acquisition module 102 determines an increase amount in the number of reactions based on the type of reaction. The number-of-reactions acquisition module 102 updates the reaction information stored in the task support database DB2 based on the determined increase amount. The number-of-reactions acquisition module 102 may decrement the number of reactions when a negative reaction is made.

The task support system 1 according to Modification Example 5 acquires, based on types of reactions to each of a plurality of pieces of data, the numbers of reactions to the piece of data. Thus, it is possible to properly use magnitudes of reactions made by the user, thereby increasing the convenience of the user.

[5-6. Modification Example 6]

For example, the number-of-reactions acquisition module 102 may acquire the number of reactions based on an attribute relating to a user who has reacted to each of a plurality of pieces of data. It is assumed that a relationship between the attribute and the number of reactions is stored in advance in the data storage unit 100. The relationship may have any format, for example, may have a table format, have a mathematical expression format, or be a part of program code. The number-of-reactions acquisition module 102 acquires the number of reactions associated with the attribute relating to the user who has reacted to a certain piece of data.

For example, the number-of-reactions acquisition module 102 acquires the number of reactions so that the increase amount of the number of reactions per reaction becomes larger as the job title of the user who has reacted to a certain piece of data becomes higher in position. That is, the number-of-reactions acquisition module 102 acquires the number of reactions so that the increase amount of the number of reactions per reaction becomes smaller as the job title of the user who has reacted to a certain piece of data becomes lower in position. In addition, for example, the number-of-reactions acquisition module 102 may perform the correction so that the number of reactions to a piece of data to which another user in the same department as that of the user has reacted becomes larger.

The number-of-reactions acquisition module 102 may obtain the number of reactions based on an attribute other than the job title. For example, when the number of people belonging to the department of a user who has made a reaction is large, a large number of reactions are likely to occur, and hence the number-of-reactions acquisition module 102 may reduce the increase amount of the number of reactions in order to suppress an influence per reaction. In contrast, when the number of people belonging to the department is small, the number-of-reactions acquisition module 102 may increase the increase amount of the number of reactions in order to increase an influence per reaction.

The task support system 1 according to Modification Example 6 acquires the number of reactions based on the attribute relating to the user who has reacted to each of a plurality of pieces of data. This enables the number of reactions to correspond to the attribute of the user, thereby increasing the convenience of the user.

[5-7. Modification Example 7]

For example, the search result screen SC3 may have any layout, and is not limited to the example of the at least one embodiment. For example, when the search results cannot be fully displayed, the display area A30 of the search result screen SC3 may be scrollable. In this case, when the display area A30 has been scrolled up to the lowest piece of data of a predetermined number of search results, a button such as “VIEW MORE” may be displayed below the piece of data to display further data search results. It is assumed that, in the case of displaying the search result screen SC3 on the display unit 25, for example, “POSTED-DATE-AND-TIME ORDER” has been designated as a default sort order. In this case, the search result screen SC3 is displayed as illustrated in FIG. 4.

It is assumed that, after that, the user changes the sort condition from “POSTED-DATE-AND-TIME ORDER” to “DESCENDING ORDER OF LIKES.” In this case, the display of the display area A30 is updated in descending order of the number of reactions among the current search results. However, search results displayed beyond the “VIEW MORE” button may include a piece of data having a larger number of reactions. This is because the default sort order was “POSTED-DATE-AND-TIME ORDER” on the initial display. When the number of reactions to a piece of data having an earlier posted date and time is larger, there may be a piece of data to which more reactions were made beyond the “VIEW MORE” button. In this case, the piece of data moves to the top immediately after the “VIEW MORE” button is selected, and it may be impossible to view the piece of data.

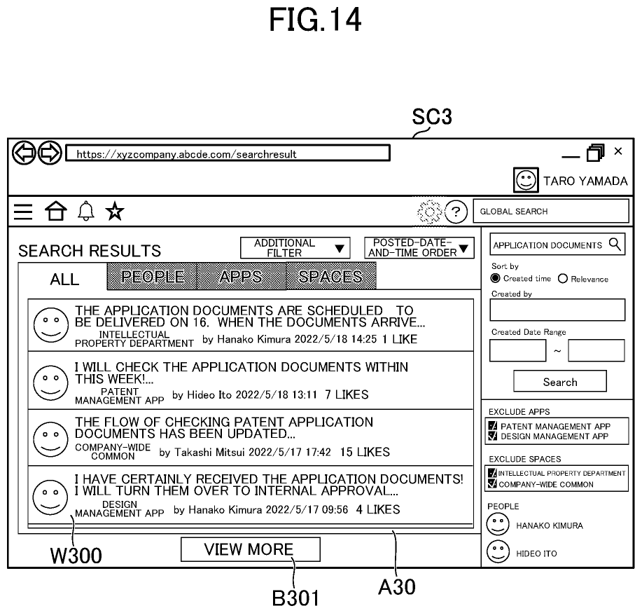

FIG. 14 is a view for illustrating an example of the search result screen SC3 in Modification Example 7. In the example of FIG. 14, a “VIEW MORE” button B301 is displayed separately from a window W300 of the display area A30 instead of being displayed at a lowermost part of the display area A30. The window W300 corresponds to the display area A30 described in the at least one embodiment, and the pieces of data included in the search results are arranged in a predetermined sort order. In the example of FIG. 14, even when the user scrolls the window W300, a display position of the “VIEW MORE” button B301 does not change. In the example of FIG. 14, the “VIEW MORE” button B301 is arranged outside the display area A30.

In the task support system 1 according to Modification Example 7, the search result screen SC3 has such a layout as illustrated in FIG. 14, to thereby allow the user to select the “VIEW MORE” button B301 under a state in which the sorting has been performed in descending order of the number of reactions with a piece of data having the most reactions thereto being displayed in the display area A30. In this case, even when a piece of data having more reactions thereto is retrieved, the piece of data is displayed in the window W300, and hence the user can notice the piece of data. Thus, it is possible to provide an interface usable to user.

[5-8. Modification Example 8]

For example, the task support system 1 can also achieve another purpose different from the purpose of “increasing convenience of a user in a task support system that allows a reaction to be made to data.” The task support system 1 can achieve a plurality of purposes. For example, there is another purpose of “executing search range switching to obtain a search range desired by the user.” This purpose can be achieved by the configuration relating to the designation of the search range described in the at least one embodiment or Modification Example 2.

The task support system 1 can achieve the above-mentioned other purposes without including the configuration for displaying the search result screen SC3 based on the number of reactions. Thus, the task support system 1 may display the search result screen SC3 irrespective of the number of reactions in particular. The task support system 1 is not required to include the reaction receiving module 101 and the number-of-reactions acquisition module 102. The display control module 105 is not required to include the functions relating to the display control based on the number of reactions.

In addition, for example, the task support system 1 can also achieve another purpose of “providing an interface usable to user” described in Modification Example 6. In this case as well, the task support system 1 is not required to include the reaction receiving module 101 and the number-of-reactions acquisition module 102. The display control module 105 may include the function described in Modification Example 7 without including the functions relating to the display control based on the number of reactions.

[5-9. Other Modification Examples]

For example, Modification Examples 1 to 8 may be combined. For example, each function described above may be implemented by any device in the task support system 1. For example, the functions described as being implemented by the server 10 may be implemented by the user terminal 20. In this case, it suffices that the same functions as the reaction receiving module 101, the number-of-reactions acquisition module 102, and the display control module 105 are implemented by being executed by a script of the browser or by being executed by an application installed in the user terminal 20. For example, the functions may be implemented by one computer instead of being shared by a plurality of computers.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A task support system for supporting each of a plurality of users in tasks, the task support system comprising at least one processor configured to:
receive a reaction to each of a plurality of pieces of data registered in the task support system;
acquire the number of reactions to each of the plurality of pieces of data; and
display, on a display unit, a search result screen that shows search results relating to the plurality of pieces of data based on the number of reactions to each of the plurality of pieces of data.

2. The task support system according to claim 1, wherein the at least one processor is configured to execute sorting relating to the search results based on the number of reactions to each of the plurality of pieces of data, and display the search result screen on the display unit.

3. The task support system according to claim 1, wherein the at least one processor is configured to execute filtering relating to the search results based on the number of reactions to each of the plurality of pieces of data, and display the search result screen on the display unit.

4. The task support system according to claim 3, wherein the at least one processor is configured to:
determine a threshold value relating to the filtering based on a group to which each of the plurality of users for which the search result screen is to be displayed on the display unit belongs; and
execute the filtering based on the threshold value.

5. The task support system according to claim 1, wherein the at least one processor is configured to:
execute filtering so that, among the plurality of pieces of data, at least one of the plurality of pieces of data to which a specific one of the plurality of users has reacted remains; and
display the search result screen on the display unit based on an execution result of the filtering.

6. The task support system according to claim 1, wherein the at least one processor is configured to:
receive designation of any one of a plurality of search ranges;
classify, after the search results are acquired, the search results based on the one of the plurality of search ranges; and
display, on the display unit, the search result screen that shows the classified search results based on the designated one of the plurality of search ranges.

7. The task support system according to claim 1, wherein the at least one processor is configured to:
receive designation of any one of a plurality of search ranges;
acquire, based on each of the plurality of search ranges, the search results for the each of the plurality of search ranges; and
display, on the display unit, the search result screen that shows the search results corresponding to the one of the plurality of search ranges designated from among the plurality of search ranges.

8. The task support system according to claim 1, wherein the at least one processor is configured to:
receive, from among a plurality of search ranges, designation of at least one of: one of the plurality of search ranges to be set as a search target; or one of the plurality of search ranges to be excluded from search targets;
identify, based on the designation, a final search range to be finally set as the search target; and
display, on the display unit, the search result screen that shows the search results within the identified final search range.

9. The task support system according to claim 1, wherein the at least one processor is configured to display the search result screen on the display unit based on the number of reactions to each of the plurality of pieces of data and the number of users who are expected to react to the each of the plurality of pieces of data.

10. The task support system according to claim 1, wherein the at least one processor is configured to:
receive, as the reaction, a comment on each of the plurality of pieces of data;
determine, when each of the plurality of users who has input the comment on each of the plurality of pieces of data has not made the reaction other than the comment to the each of the plurality of pieces of data, whether the comment contains a detail equivalent to the reaction other than the comment; and
acquire the number of reactions based on a result of the determination.

11. The task support system according to claim 1, wherein the at least one processor is configured to:
receive each of a plurality of types of reactions; and
acquire, based on a type of the reaction to each of the plurality of pieces of data, the number of reactions to the each of the plurality of pieces of data.

12. The task support system according to claim 1, wherein the at least one processor is configured to acquire the number of reactions based on an attribute relating to each of the plurality of users who has made the reaction to the each of the plurality of pieces of data.

13. A task support method for supporting each of a plurality of users in tasks, the task support method comprising:
receiving a reaction to each of a plurality of pieces of data registered in a task support system;
acquiring the number of reactions to each of the plurality of pieces of data; and
displaying, on a display unit, a search result screen that shows search results relating to the plurality of pieces of data based on the number of reactions to each of the plurality of pieces of data.

14. A non-transitory information storage medium having stored thereon a program for causing a computer for supporting each of a plurality of users in tasks to:
receive a reaction to each of a plurality of pieces of data registered in a task support system;
acquire the number of reactions to each of the plurality of pieces of data; and
display, on a display unit, a search result screen that shows search results relating to the plurality of pieces of data based on the number of reactions to each of the plurality of pieces of data.
